(19) United States
(12) Patent Application Publication
(10) Pub. No.: US 2023/0302525 A1
(43) Pub. Date: Sep. 28, 2023

(54) HYDRAULIC EXPANSION OF OVAL TUBES IN TUBE SHEET

(71) Applicant: Carrier Corporation, Palm Beach Gardens, FL (US)

(72) Inventors: Thomas Bryant, West Seneca, NY (US); Luis Avila, Manlius, NY (US); Paul Haydock, Indianapolis, IN (US)

(21) Appl. No.: 18/187,161

(22) Filed: Mar. 21, 2023

Related U.S. Application Data
(60) Provisional application No. 63/323,637, filed on Mar. 25, 2022.

(51) Int. Cl. B21D 53/08; B23P 15/26

(52) U.S. Cl. CPC B21D 53/08; B23P 15/26

(57) ABSTRACT

A swaging tool for use with a non-circular heat exchange tube including a body having a first sealing surface positionable in contact with the heat exchange tube to form a first seal with the heat exchange tube and a second sealing surface positionable in contact with the heat exchange tube to form a second seal with the heat exchange tube. At least one fluid channel is formed in the body and is connected to an outlet port. The outlet port is arranged between the first sealing surface and the second sealing surface.

### CROSS-REFERENCE TO RELATED APPLICATIONS

This application claims the benefit of U.S. Application No. 63/323,637, filed Mar. 25, 2022, the contents of which are incorporated by reference herein in their entirety.

### BACKGROUND

Embodiments of the present disclosure relate to the art of heat exchangers, and more particularly to a method of mechanically expanding the tubes of the heat exchanger.

Heat exchangers typically require a seal to be formed between the heat exchange tubes and the tube sheets and liner of the heat exchanger. In heat exchangers having round tubes, this seal is typically formed by mechanically swaging the round tubes. However, heat exchangers having heat exchange tubes of other non-circular shapes are not suitable for use with these standard swaging techniques. The forces that can be applied to the heat exchange tubes mechanically are limited by the column strength of the tube. In particular, non-circular tubes can deform and lose their non-circular geometric aspect ratio and shape as a consequence of using standard swaging techniques which are designed for even deformation as would be the case with typical round tubes. This unintended deformation can affect the performance of the tube, and the product containing the tube. In addition, if a heat exchange tube is integrated into a matrix prior to formation of the seal, the ability to support the heat exchanger tube to perform such a swaging operation is limited.

### BRIEF DESCRIPTION

According to an embodiment, a swaging tool for use with a non-circular heat exchange tube including a body having a first sealing surface positionable in contact with the heat exchange tube to form a first seal with the heat exchange tube and a second sealing surface positionable in contact with the heat exchange tube to form a second seal with the heat exchange tube. At least one fluid channel is formed in the body and is connected to an outlet port. The outlet port is arranged between the first sealing surface and the second sealing surface.

In addition to one or more of the features described herein, or as an alternative, in further embodiments only a portion of the body is receivable within the interior of the heat exchange tube.

In addition to one or more of the features described herein, or as an alternative, in further embodiments the body includes a first portion and a second portion, the first portion being receivable within an interior of the heat exchange tube, wherein the first sealing surface is arranged centrally relative to the first portion and the second sealing surface is arranged at an end of the first portion.

In addition to one or more of the features described herein, or as an alternative, in further embodiments a cross-sectional shape of the body is similar to a cross-sectional shape of the heat exchange tube.

In addition to one or more of the features described herein, or as an alternative, in further embodiments the body has an oval cross-sectional shape.

In addition to one or more of the features described herein, or as an alternative, in further embodiments the cross-sectional shape and size of the body between the first sealing surface and the second sealing surface is substantially equal to the cross-sectional shape and size of the heat exchange tube.

In addition to one or more of the features described herein, or as an alternative, in further embodiments the at least one fluid channel includes a plurality fluid channels.

In addition to one or more of the features described herein, or as an alternative, in further embodiments the plurality of fluid channels are spaced about the cross-sectional shape of the body.

According to an embodiment, a method of expanding a heat exchange tube to form a seal with an adjacent component includes inserting a swaging tool into an interior of the heat exchange tube, forming a first seal and a second seal between the swaging tool and the heat exchange tube, increasing a pressure between the first seal and the second seal, and mechanically expanding an area of the heat exchange tube between the first seal and the second seal in response to the increase in the pressure.

In addition to one or more of the features described herein, or as an alternative, in further embodiments increasing the pressure between the first seal and the second seal further comprises supplying a hydraulic fluid to at least one fluid channel formed in the swaging tool.

In addition to one or more of the features described herein, or as an alternative, in further embodiments an outlet port of the at least one fluid channel extends to an exterior of the swaging tool at a location between the first seal and the second seal.

In addition to one or more of the features described herein, or as an alternative, in further embodiments forming the first seal and the second seal between the swaging tool and the heat exchange tube further comprises sliding the swaging tool within the interior of the heat exchange tube such that a first sealing surface and a second sealing surface of the swaging tool contact the interior of the heat exchange tube.

In addition to one or more of the features described herein, or as an alternative, in further embodiments the adjacent component further comprises a tube sheet and sliding the swaging tool within the interior of the heat exchange tube further comprises positioning the first sealing surface inward of the tube sheet relative to an end of the heat exchange tube.

In addition to one or more of the features described herein, or as an alternative, in further embodiments the adjacent component further comprises a liner and sliding the swaging tool within the interior of the heat exchange tube further comprises positioning the second sealing surface outward of the liner relative to the end of the heat exchange tube.

According to an embodiment, a method of sealing a plurality of heat exchange tubes to an adjacent component includes installing a first swaging tool at a first end of a heat exchange tube of the plurality of heat exchange tubes, installing a second swaging tool at a second end of the heat exchange tube of the plurality of heat exchange tubes, and mechanically expanding the first end of the heat exchange tube via the first swaging tool and mechanically expanding the second end of the heat exchange tube via the second swaging tool simultaneously.

In addition to one or more of the features described herein, or as an alternative, in further embodiments the first swaging tool and the second swaging tool are substantially identical.

In addition to one or more of the features described herein, or as an alternative, in further embodiments a plurality of fins are affixed to the plurality of heat exchange tubes during the mechanical expansion.

In addition to one or more of the features described herein, or as an alternative, in further embodiments the adjacent component further comprises at least one of a liner and a tube sheet, and mechanically expanding the first end and the second end of the heat exchange tube further comprises sealing the heat exchange tube to the at least one of the liner and the tube sheet.

In addition to one or more of the features described herein, or as an alternative, in further embodiments a cross-sectional shape of the heat exchange tube is non-circular.

In addition to one or more of the features described herein, or as an alternative, in further embodiments a cross-sectional size and shape of the first swaging tool and the second swaging tool is similar to a cross-sectional size and shape of an interior of the heat exchange tube.

### BRIEF DESCRIPTION OF THE DRAWINGS

The following descriptions should not be considered limiting in any way. With reference to the accompanying drawings, like elements are numbered alike:

FIG. 1 is a perspective view of an exemplary portion of a heat exchanger coil according to an embodiment;

FIG. 2 is a perspective view of the heat exchanger coil of FIG. 1 without the liner according to an embodiment;

FIG. 3A is a perspective view of an exemplary swaging tool for use with a heat exchange tube according to an embodiment;

FIG. 3B is a side view of the swaging tool of FIG. 3A according to an embodiment;

FIG. 4 is a perspective view of an exemplary swaging tool installed within a heat exchange tube according to an embodiment;

FIG. 5 is a perspective cross-sectional view of the swaging tool of FIG. 4 according to an embodiment; and

FIG. 6 is a cross-sectional view of the swaging tool of FIGS. 3A and 3B installed within a heat exchange tube according to an embodiment.

### DETAILED DESCRIPTION

A detailed description of one or more embodiments of the disclosed apparatus and method are presented herein by way of exemplification and not limitation with reference to the Figures.

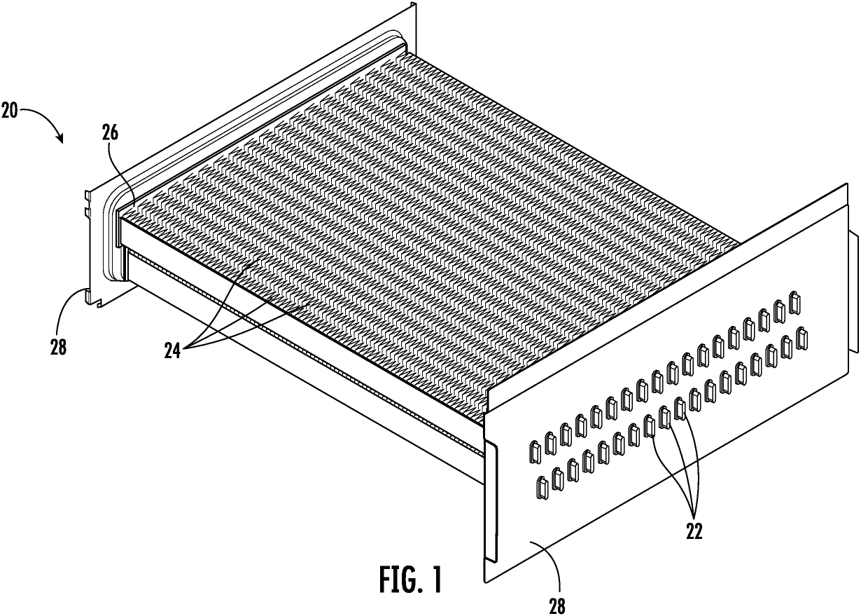

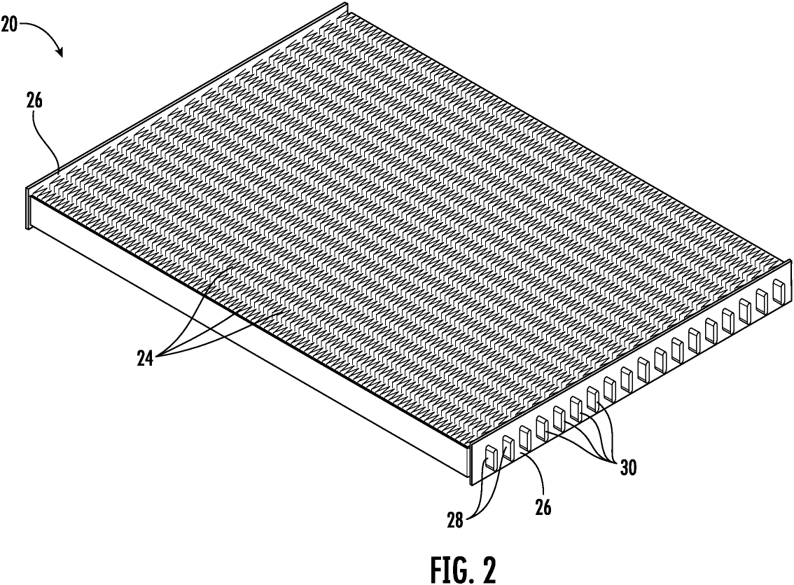

Referring to FIGS. 1 and 2, an exemplary heat exchanger coil 20 is illustrated. As shown, the heat exchanger coil 20 includes a plurality of heat exchange tubes 22 extending in a spaced parallel relationship. In an embodiment, the plurality of heat exchange tubes 22 are substantially uniform and have an oval cross-sectional shape. A plurality of heat transfer fins 24 may be disposed between and rigidly attached, such as by a furnace braze process or another suitable process, for example, to an exterior surface of the heat exchange tubes 22 to enhance external heat transfer and provide structural rigidity to the heat exchanger coil 20. The fins 24 may be configuration with any suitable configuration. In an embodiment, each fin 24 is formed from a plurality of connected strips, or alternatively, from a single continuous strip of fin material folded tightly in a ribbon-like, serpentine fashion. In the illustrated, non-limiting embodiment, heat exchange between the fluid within the interior of the heat exchange tubes 22 and a secondary fluid occurs at the outside surfaces of the heat exchange tubes 22 and also through the heat exchange surface of the fins 24. The fluids may be different types, for example, the fluid flowing through tubes 22 can be a refrigerant and the fluid flowing through the fins 24 and over the tubes 22 can be air. However, embodiments where the fluids are the same type of fluid are also contemplated herein.

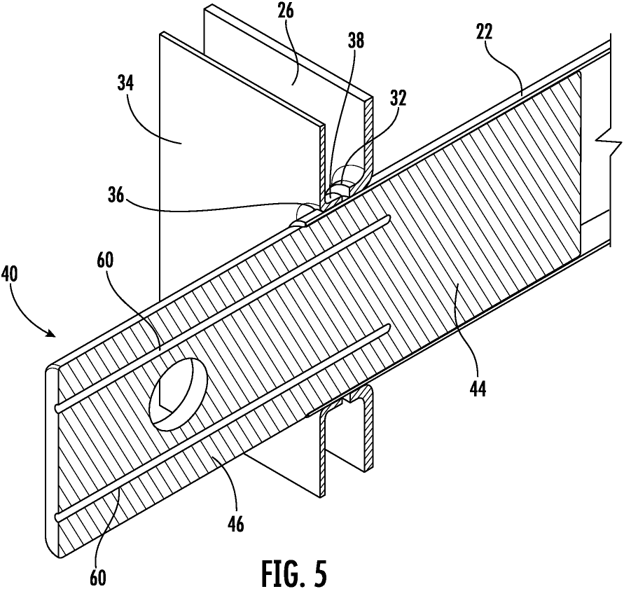

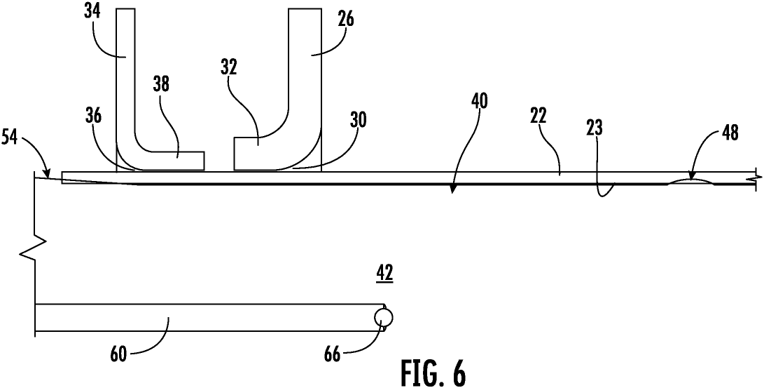

As shown in FIG. 2, a tube sheet 26 is arranged near each end 28 of the plurality of heat exchange tubes 22. The tube sheet 26 has a plurality of holes 30 complementary to the plurality of heat exchange tubes 22 formed therein. Each hole 30 in the tube sheet 26 may, but need not include a tube sheet collar 32 (see FIGS. 5 and 6) which extends outwardly towards the end 28 of the heat exchange tubes 22. The plurality of heat exchange tubes 22 are laced through the holes 30 in the tube sheets 26. In an embodiment, the heat exchange tubes 22 are arranged in contact with the tube sheet 26 via the tube sheet collars 32. A liner 34 is axially spaced from the tube sheet 26 toward the end 28 of the heat exchange tubes 22 such that a liner space is formed between the liner 34 and the tube sheet 26. In an embodiment, the liner 34 includes a plurality of liner openings 36 through which the plurality of heat exchange tubes 22 pass. Each liner opening 36 may include a liner collar 38 which extends towards, and in some embodiments abuts the tube sheet collar 32. In an embodiment, each of the plurality of heat exchange tubes 22 is arranged in contact with the liner 34 via the liner collars 38.

In the illustrated, non-limiting embodiment of FIGS. 1 and 2, the heat exchanger coil 20 is a staggered two-row coil. However, it should be understood that a heat exchanger coil 20 having any number of rows of heat exchange tubes 22, such as only a single row of tubes, or more than two rows of tubes, and also a heat exchanger coil 20 where the heat exchange tubes 22 in adjacent rows are staggered or aligned are within the scope of the disclosure.

The heat exchange tubes 22 are typically attached to an adjacent component, such as the liners 34 and/or the tube sheets 26 via a swaging process such that a seal is created therebetween. However, in embodiments where the heat exchange tube does not have a circular cross-section, the heat exchange tube is more susceptible to deflection during the swaging process. In addition, in instances where the fins 24 are already attached to the heat exchange tubes 22 as an integrated unit before the tubes 22 are attached to the tube sheets 26 and/or liners 34, there are limits on how the heat exchange tubes 22 can be externally supported.

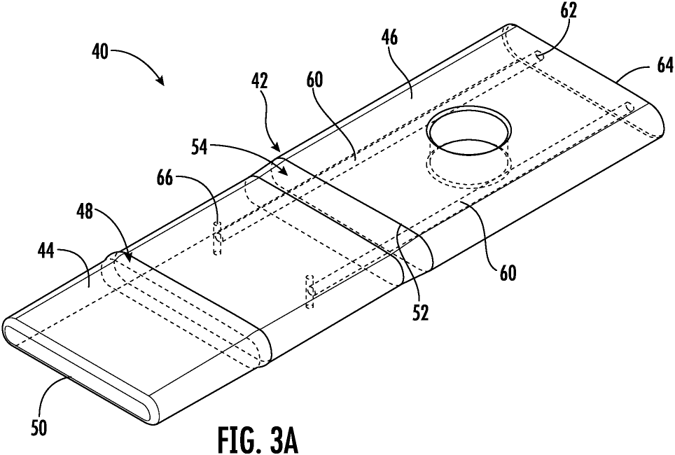

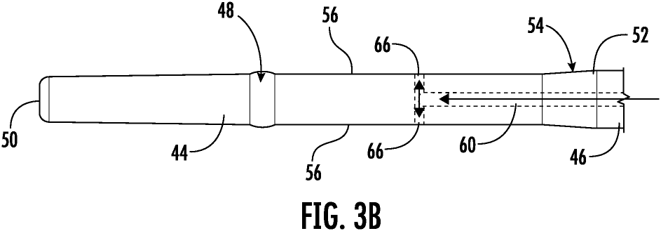

With reference now to FIGS. 3A and 3B, an exemplary swaging tool 40 for use with a non-circular heat exchange tube 22 or a heat exchange tube that is not axisymmetric is illustrated. As shown, the tool 40 has a body 42 having a cross-sectional shape complementary or similar to the cross-sectional shape of the heat exchange tubes 22. As shown, the body 42 has a generally oval cross-sectional shape. The body 42 may be formed from a substantially solid material. In the illustrated, non-limiting embodiment, the body 42 includes a first portion 44 receivable within the hollow interior of the heat exchange tube 22 and a second portion 46 that remains at an exterior of the heat exchange tube 22. such as extending from the end 28 thereof, when the tool 40 is in use.

The cross-sectional size and shape of the second portion 46 of the body 42 may remain substantially constant over its length, measured parallel to a longitudinal axis of the tool 40 and the heat exchange tube 22. The cross-sectional size and shape of the first portion 44 of the body 42 may be constant over all or at least a portion of the axial length thereof. In an embodiment, the cross-sectional size, and therefore area, may vary over part of the axial length of the first portion 44. For example, the first portion 44 of the body 42 may include an expanded region 48 arranged centrally between a first end 50 of the first portion 44 and a second end 52 of the first portion 44. At this expanded region 48. a cross-sectional area of the body 42 is greater than the cross-sectional area of the body 42 adjacent thereto. As a result, the surface of the body 42 at the expanded region 48 protrudes from or is bumped out relative to the remainder of the first portion 44 of the body 42. In such embodiments, the expanded region 48 may be configured as a first sealing surface operable to seal against the interior surface 23 of the heat exchange tube 22 at a desired axial location, such as at a location inward of both the tube sheet 26 and the liner 34 relative to the end 28 of the heat exchange tube.

In an embodiment, the cross-sectional area extending from the expanded region 48 to the first end 50 of the first portion 44 of the body 42 gradually decreases over the axial length of the body 42. As a result, the outer surface of the first portion 44 gradually tapers towards the first end 50 of the body 42. Reducing the size of the first end 50 of the first portion 44 of the body 42 may facilitate insertion of the tool 40 into the hollow interior of a heat exchange tube 22. However, it should be understood that embodiments where the cross-sectional area of the first portion 44 is constant between the first end 50 and the expanded region 48 are also within the scope of the disclosure.

The cross-sectional area of the first portion 44 extending between the expanded region 48 and the second end 52 thereof may be generally constant. For example, the cross-sectional area may be substantially equal to the cross-sectional area of the hollow interior of a heat exchange tube 22. In an embodiment, the cross-sectional area of the tool 40 gradually increases adjacent to the second end 52 of the first portion 44. such as between about 90% and about 100% of the axial length of the first portion 44 for example. The angle of the taper, identified at 54, resulting from the increase in the cross-sectional area adjacent to the second end 52 may be equal to or greater than the angle of the taper extending between the first end 50 and the expanded region 48. The taper 54 at the second end 52 of the first portion 44 may be configured as a second sealing surface operable to form a seal with the interior surface 23 of the heat exchange tube 22 when the tool 40 is installed within the heat exchange tube 22. The seal formed by the taper will be at a desired axial location, such as at a location outward of both the tube sheet 26 and the liner 34 relative to the end 28 of the heat exchange tube 22.

At least one fluid channel 60 is formed at an interior of the body 42 of the tool 40. In the illustrated, non-limiting embodiment, the body 42 includes two parallel fluid channels 60; however, it should be understood that a tool 40 having a single fluid channel, and a tool 40 having more than two fluid channels are also contemplated herein. In embodiments including a plurality of fluid channels 60, the fluid channels are spaced apart from one another. As shown, each fluid channel 60 extends between an inlet port 62 formed at the exterior of the body 42, such as at the distal end 64 of the second portion 46 of the body 42, and at least one outlet port 66 located at the first portion 44 of the body 42. It should further be understood that embodiments where multiple fluid channels 60 are coupled to the same inlet port 62 or to the same outlet port 66 are also contemplated herein. In the illustrated, non-limiting embodiment, the outlet port 66 includes two outlet ports formed at opposite sidewalls 56 of the first portion 44 of the body 42. such as at a location between the expanded region 48 and the taper for example. However, embodiments having only a single outlet port 66 are also contemplated herein. Further, although the outlet port 66 is shown as being oriented substantially orthogonal or perpendicular to the fluid channel, embodiments where an outlet port 66 extends at another non-parallel angle relative to the fluid channel 60 are also within the scope of the disclosure.

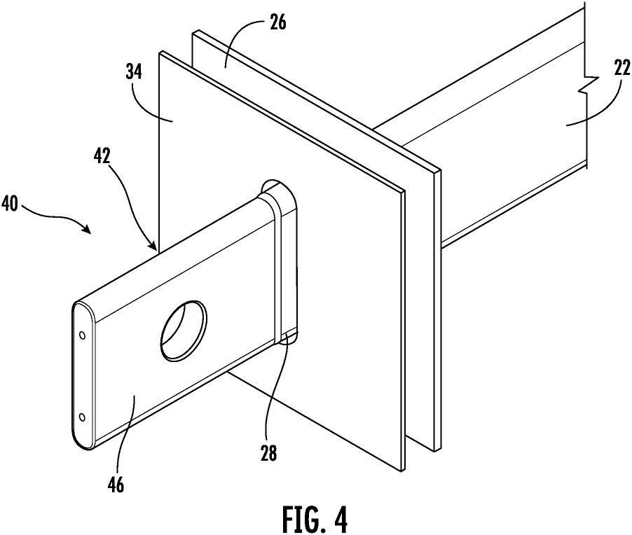

In operation, as shown in FIGS. 4-6, the first end 50 of the tool 40 is inserted into the hollow interior of a heat exchange tube 22. The tool is inserted such that a first seal is formed between the surface 23 of the heat exchange tube 22 and the expanded region 48 and a second seal is formed between the surface 23 of the heat exchange tube 22 and the taper 54. A hydraulic fluid F is delivered to the one or more fluid channels 60 to increase the pressure within the tool 40. and therefore the pressure applied to the interior surface 23 of the heat exchange tube 22 between the first seal and the second seal. This force causes the material of the tube 22 to expand, thereby creating a tight seal between the exterior of the heat exchange tube 22 and the liner collar 38 and tube sheet collar 32. In an embodiment, each heat exchange tube 22 may be sealed to a respective liner 34 and tube sheet 26 via a respective mechanical expansion operation using the tool 40. However, embodiments where a mechanical expansion operation is performed on adjacent ends of a plurality of heat exchange tubes 22 simultaneously are also within the scope of the disclosure. In some embodiments, a first swaging tool 40 is inserted into a first end of a heat exchange tube 22 and a second swaging tool is inserted into an opposite second end of the same heat exchange tubes such that both ends of the heat exchange tube 22 are sealed to a respective liner 34 and/or tube sheet 26 simultaneously during a mechanical expansion operation. In such embodiments, the first tool associated with a first end and a second tool associated with a second end of the heat exchange tube may be substantially identical. By performing the mechanical expansion at both ends of the heat exchange tube 22 simultaneously, the dimension of the heat exchange tube 22 may be preserved.

Use of a tool 40 as described herein limits the force acting on the heat exchange tube 22 to the specific area of the tube located between the seals. As a result, the risk of buckling of the heat exchange tube 22 is minimized or eliminated. In addition, because the cross-section of the tool 40 is similar in size and shape to the heat exchange tube 22, movement of the material of the heat exchange tube 22 is restricted to maintain the ovality thereof, while also achieving an even seal about the perimeter of the tube 22.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A swaging tool for use with a non-circular heat exchange tube, the swaging tool comprising:
a body including a first sealing surface positionable in contact with the heat exchange tube to form a first seal with the heat exchange tube and a second sealing surface positionable in contact with the heat exchange tube to form a second seal with the heat exchange tube; and
at least one fluid channel formed in the body and connected to an outlet port, the outlet port being arranged between the first sealing surface and the second sealing surface.

2. The swaging tool of claim 1, wherein only a portion of the body is receivable within the interior of the heat exchange tube.

3. The swaging tool of claim 1, wherein the body includes a first portion and a second portion, the first portion being receivable within an interior of the heat exchange tube, wherein the first sealing surface is arranged centrally relative to the first portion and the second sealing surface is arranged at an end of the first portion.

4. The swaging tool of claim 1, wherein a cross-sectional shape of the body is similar to a cross-sectional shape of the heat exchange tube.

5. The swaging tool of claim 4, wherein the body has an oval cross-sectional shape.

6. The swaging tool of claim 4, wherein the cross-sectional shape and size of the body between the first sealing surface and the second sealing surface is substantially equal to the cross-sectional shape and size of the heat exchange tube.

7. The swaging tool of claim 1, wherein the at least one fluid channel includes a plurality fluid channels.

8. The swaging tool of claim 1, wherein the plurality of fluid channels are spaced about the cross-sectional shape of the body.

9. A method of expanding a heat exchange tube to form a seal with an adjacent component, the method comprising:
inserting a swaging tool into an interior of the heat exchange tube;
forming a first seal and a second seal between the swaging tool and the heat exchange tube;
increasing a pressure between the first seal and the second seal; and
mechanically expanding an area of the heat exchange tube between the first seal and the second seal in response to the increase in the pressure.

10. The method of claim 9, wherein increasing the pressure between the first seal and the second seal further comprises supplying a hydraulic fluid to at least one fluid channel formed in the swaging tool.

11. The method of claim 10, wherein an outlet port of the at least one fluid channel extends to an exterior of the swaging tool at a location between the first seal and the second seal.

12. The method of claim 9, wherein forming the first seal and the second seal between the swaging tool and the heat exchange tube further comprises sliding the swaging tool within the interior of the heat exchange tube such that a first sealing surface and a second sealing surface of the swaging tool contact the interior of the heat exchange tube.

13. The method of claim 12, wherein the adjacent component further comprises a tube sheet and sliding the swaging tool within the interior of the heat exchange tube further comprises positioning the first sealing surface inward of the tube sheet relative to an end of the heat exchange tube.

14. The method of claim 13, wherein the adjacent component further comprises a liner and sliding the swaging tool within the interior of the heat exchange tube further comprises positioning the second sealing surface outward of the liner relative to the end of the heat exchange tube.

15. A method of sealing a plurality of heat exchange tubes to an adjacent component, the method comprising:
installing a first swaging tool at a first end of a heat exchange tube of the plurality of heat exchange tubes;
installing a second swaging tool at a second end of the heat exchange tube of the plurality of heat exchange tubes; and
mechanically expanding the first end of the heat exchange tube via the first swaging tool and mechanically expanding the second end of the heat exchange tube via the second swaging tool simultaneously.

16. The method of claim 15, wherein the first swaging tool and the second swaging tool are substantially identical.

17. The method of claim 15, wherein a plurality of fins are affixed to the plurality of heat exchange tubes during the mechanical expansion.

18. The method of claim 15, wherein the adjacent component further comprises at least one of a liner and a tube sheet, and mechanically expanding the first end and the second end of the heat exchange tube further comprises sealing the heat exchange tube to the at least one of the liner and the tube sheet.

19. The method of claim 15, wherein a cross-sectional shape of the heat exchange tube is non-circular.

20. The method of claim 15, wherein a cross-sectional size and shape of the first swaging tool and the second swaging tool is similar to a cross-sectional size and shape of an interior of the heat exchange tube.
